(19) United States
(12) Patent Application Publication
(10) Pub. No.: US 2009/0181194 A1
(43) Pub. Date: Jul. 16, 2009

(54) HOUSING OF PORTABLE ELECTRONIC DEVICE AND METHOD FOR FABRICATING THE SAME

(75) Inventors: TAO ZHANG, Shenzhen City (CN); XIAO-LIN FENG, Shenzhen City (CN); TUN GAO, Shenzhen City (CN); MING TANG, Shenzhen City (CN); YUE-PING ZHOU, Shenzhen City (CN)

Correspondence Address: PCE INDUSTRY, INC.;ATT. Steven Reiss, 458 E. LAMBERT ROAD, FULLERTON, CA, 92835, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/133,522

(22) Filed: Jun. 5, 2008

(30) Foreign Application Priority Data
Jan. 14, 2008 (CN) 200810300087.9

(51) Int. Cl. B32B 3/10; B32B 37/04

(52) U.S. Cl. 428/35.7; 156/108

(57) ABSTRACT

A housing (100) of a portable electronic device includes an opaque base (10) and a transparent cover (20). The base defines an aperture (101). The cover is fixed on the base by means of laser soldering and covers the aperture. A method for fabricating the housing is also described.

### BACKGROUND OF THE INVENTION

1. Field of the Invention

The present invention generally relates to housings of portable electronic devices and a method for fabricating the same, particularly to a housing of a portable electronic device having an image sensing module and a method for fabricating the same.

2. Description of Related Art

Nowadays, portable electronic devices, such as mobile phones, laptops and personal digital assistants (PDAs) are widely used. Many portable electronic devices have digital camera modules installed therein, thus the portable electronic devices can be used to capture images.

In fabrication of a portable electronic device having a digital camera module, a housing of the portable electronic device defines an aperture therein to expose the digital camera module for receiving outside image signals, and has a transparent cover mounted on the housing and covering the aperture to protect the digital camera module. Generally, in typical fabricating methods, the cover is soldered onto the housing by ultrasonic means or glued onto the housing. However, the method of gluing the cover on the housing is costly and difficult, and the method of soldering the cover on the housing by ultrasonic means may create a housing and cover that does not have a smooth surface.

Therefore, a new housing of a portable electronic device and a method for fabricating the same is desired in order to overcome the above-described shortcomings.

### BRIEF DESCRIPTION OF THE DRAWINGS

Many aspects of the new housing and method for fabricating the same can be better understood with reference to the following drawings. The components in the drawings are not necessarily drawn to scale, the emphasis instead being placed upon clearly illustrating the principles of the new housing and method for fabricating the same. Moreover, in the drawings, like reference numerals designate corresponding parts throughout the several views.

FIG. 1 is an assembled view of a housing according to an exemplary embodiment.

FIG. 2 is a disassembled view of the housing shown in FIG. 1.

FIG. 3 is a schematic view of a cover of the housing shown in FIG. 1.

FIG. 4 is an enlarged, cross-sectional view along the line IV-IV shown in FIG. 1.

### DETAILED DESCRIPTION OF THE INVENTION

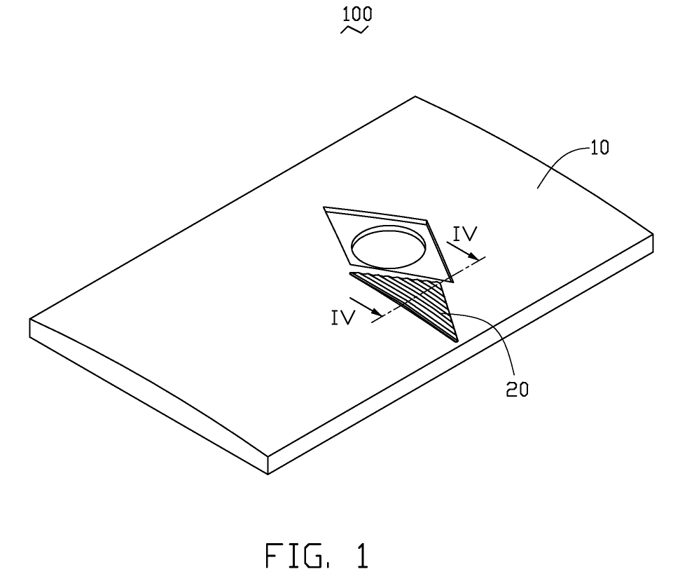

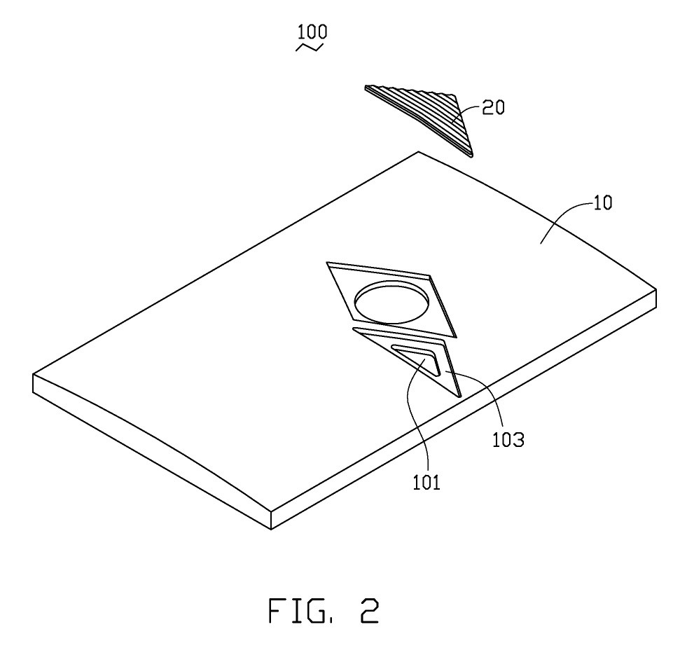

Referring to FIG. 1 and FIG. 2, a housing 100 according to an exemplary embodiment is shown. The housing 100 is used in a portable electronic device, such as a mobile phone.

The housing 100 includes a base 10 and a cover 20 mounted on the base 10 by means of laser soldering. The base 10 is made of opaque plastic materials, such as polythene, polypropylene, polyvinyl chloride (PVC), acrylonitrile-butadiene-styrene, etc. The base 10 defines an aperture 101 configured for exposing a digital camera module of the portable electronic device and a mounting recess 103 configured for receiving the cover 20 therein. A shape, a size and a depth of the mounting recess 103 are respectively formed to be equal to a shape, a size and a thickness of the cover 20. The aperture 101 is defined in a central portion of the mounting recess 103.

The cover 20 is made of transparent materials having similar chemical characters and melting point as that of the base 10, such as polystyrene, polycarbonate (PC), polymethyl methacrylate (PMMA), etc. The cover 20 is used to cover the aperture 101 so as to protect the digital camera module and screen outside images with the digital camera module from the aperture 101.

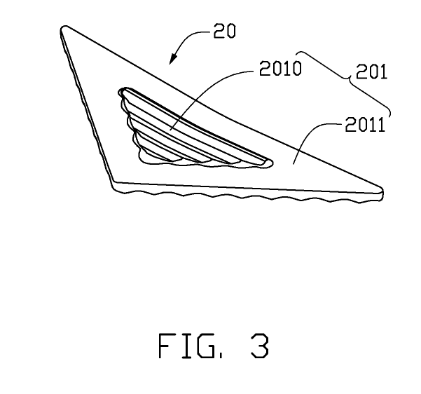

Also referring to FIG. 3, the cover 20 is a transparent board and includes a mounting surface 201. The mounting surface 201 includes an undulating central portion 2010 and a flat mounting portion 2011 formed on a periphery thereof. The central portion 2010 forms a grating configured for improving optical quality of the cover 20. A shape and size of the mounting portion 2011 is formed to be corresponding to that of the mounting recess 103.

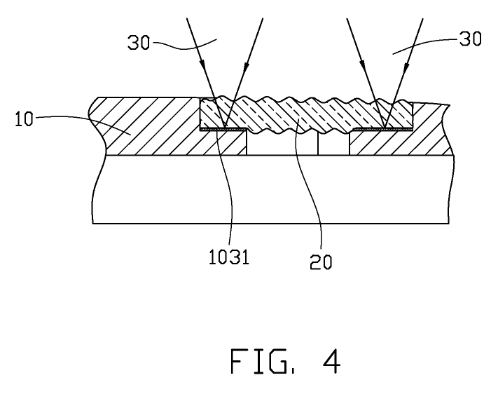

Also referring to FIG. 4, a method of laser soldering according to an exemplary embodiment, for fabricating the housing 100, is shown. The method includes these following steps.

First, a base 10 and a cover 20 are provided.

Second, the cover 20 is placed inside the mounting recess 103, with the mounting portion 2011 in contact with the bottom of the mounting recess 103, and the central portion 2010 covering the aperture 101.

Third, a laser generator (not shown) is provided and used to generate a laser beams 30. The laser beams 30 transmit through the cover 20 and are focused on the bottom of the mounting recess 103. Therefore, the laser beams 30 melt a surface layer 1031 of the bottom of the mounting recess 103, and the mounting portion 2011 is attached onto the melted surface layer 1031.

Fourth, the laser beams 30 are turned off, the melted surface layer 1031 of the base 10 cools down fixing the mounting portion 2011 thereon. Thus, the cover 20 is fixed to the base 10 and covers the aperture 101, and the housing 100 is completed.

Understandably, the laser beam 30 can also be focused on the mounting portion 2011 of the cover 20 to melt a surface layer of the mounting portion 2011, thus the cover 20 is attached onto the base 10 via its melted surface layer 1031 and fixed thereon after the surface layer of the cover 20 cools down.

The present housing 100 fabricated by the present method of laser soldering is tested in many aspects, such as ability to withstand pulling, impacts, and high and low temperatures. In experiments, the housing 100 resists a pulling power of about 100 Newtons, impact of falling from a height of about 1.0 meters for more than 100 times, and a temperature range of about −40° C.-85° C. Therefore, the present housing 100 is proved to have a higher quality than that of typical housings. The present method needs no glue to fix the cover 20 onto the base 10, thus costs less while obtaining higher mechanical qualities and optical qualities than would be obtained if a gluing process were used. Furthermore, the present method leaves a smoother surface than that of the method of ultrasonic soldering.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A housing of a portable electronic device, comprising:
an opaque base defining an aperture; and
a transparent cover fixed on the base by means of laser soldering and covering the aperture.

2. The housing as claimed in claim 1, wherein the base is made of materials chosen from a group consisting of polythene, polypropylene, polyvinyl chloride (PVC), and acrylonitrile-butadiene-styrene.

3. The housing as claimed in claim 1, wherein the cover is made of materials chosen from a group consisting of polystyrene, polycarbonate (PC), and polymethyl methacrylate (PMMA).

4. The housing as claimed in claim 1, wherein the base defines a mounting recess to receive the cover therein, and the aperture is defined in a central portion of the mounting recess.

5. The housing as claimed in claim 4, wherein the cover includes a mounting surface, a flat mounting portion corresponding to the mounting recess being formed on a periphery of the mounting surface.

6. The housing as claimed in claim 1, wherein the cover has a melting point similar to that of the base.

7. A method for fabricating a housing of a portable electronic device, comprising:
providing a base defining an aperture therein and a transparent cover;
focusing a laser on the base to melt a surface layer thereof;
attaching the cover onto the base via the melted surface layer; and
cooling down the melted surface layer to fix the cover on the base and close the aperture.

8. The method as claimed in claim 7, further comprising a step of positioning the cover in contact with the base to cover the aperture after the step of providing the base and the cover.

9. The method as claimed in claim 7, wherein the base is opaque.

10. The method as claimed in claim 7, wherein the cover has a melting point similar to that of the base.
